(19) United States
(12) Patent Application Publication
(10) Pub. No.: US 2005/0154642 A1
(43) Pub. Date: Jul. 14, 2005

(54) Local or public network of automatic document machines

(76) Inventor: Alejandro Wiechers, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/755,551

(22) Filed: Jan. 12, 2004

(51) Int. Cl. G06G 1/12

(52) U.S. Cl. 705/21

(57) ABSTRACT

An apparatus for publishing a customized document includes an interface to a network of computing devices, a search engine for accessing content of interest, and a device for printing and finishing a document including content from a content provider. In one embodiment, the apparatus for publishing a customized document is housed within a kiosk. The device for printing and finishing a customized document further includes an imaging device, and a finishing device. A method for producing a document at a point of need includes selecting content for the document, printing the document, and finishing the document. The selection of content, printing and finishing are done at the point of need. The method also includes designing the document at the point of need.

### FIELD OF THE INVENTION

The present invention relates to printers or multi-function machines that include a printing function. In particular, the present invention relates to a network

### BACKGROUND OF THE INVENTION

When a consumer wants to purchase reading material directed at an area of personal interest, most consumers purchase several magazines or books related to the general category of their interest. There is no way to select very specific materials at a bookshop. As a result, the consumer typically selects reading materials in a general category of interest hoping to find a few articles that he or she is specifically interested in. For example, a consumer will purchase a magazine directed to some area of interest. One or two articles may catch the consumer's eye. The consumer will typically read the selected articles in a magazine. The articles of interest may be torn out or clipped for later use. The remaining articles go unread. Eventually, the magazine is discarded and most of the articles are unread. The majority of the magazine is wasted. In addition, magazines are in limited supply, so a particular retail bookshop may be out of stock. In addition, if a magazine does not sell out, the extras are shipped back to the supplier for a refund. It is difficult, at times, for the demand for a magazine to meet the supply.

Some books are purchased for a different reason. However, in some instance a consumer may purchase a book a portion of which is of interest. The majority of the book goes unread. Books are generally saved for a longer period of time before being discarded or reused. Again, the result is a very inefficient delivery of materials.

In other instances, very specific materials may be needed for sales presentations. The materials may be located remote from a sales office. In this instance, the sales material must be sent for and obtained before going into a packet for marketing. Therefore, putting together a sales presentation for a specific machine may require at least several days lead time. In addition, the person seeking the sales or marketing material is not in control of most of the work necessary to produce the sales material. One alternative is to carry an inventory of brochures at each sales office. This requires space. The sales office also runs the risk of not having the latest revision. Furthermore, the brochures are generally written to a broad audience so that the information is useful for many who would read it. General sales or marketing material is not tailored to a specific person for a proposal. To customize such a brochure or presentation requires a trip to the printer. Again, this requires days of lead time to design the customized brochure, produce a proof before printing, inspect the proof, and then actually print. Since the process is so involved, custom brochures typically are made in large quantities rather than in small quantities.

### BRIEF DESCRIPTION OF THE DRAWINGS

The invention is pointed out with particularity in the appended claims. However, a more complete understanding of the present invention may be derived by referring to the detailed description when considered in connection with the figures wherein like reference numbers refer to similar items throughout the figures and:

FIG. 1 is a perspective view of a point of need printing device, according to an embodiment of this invention.

FIG. 2 is a perspective view of a point of need printing device kiosk, according to an embodiment of this invention.

FIG. 3 is a schematic view of an imaging device, according to an embodiment of this invention.

FIG. 4 is a schematic diagram of a computer system, portions of which are included in the imaging device, according to an embodiment of this invention.

FIG. 5 is a schematic diagram of an electronic device that includes the controller and memory, according to an embodiment of the invention.

FIG. 6 is a schematic diagram of an in-line finisher, according to an embodiment of this invention.

FIG. 7 is a partially exploded view illustrating a lamination imaging system of the in-line finisher, having a lamination module projecting therefrom, according to an embodiment of this invention.

FIG. 8 is a flow diagram of a lamination finishing sequence executed by the lamination module of FIG. 7, according to an embodiment of this invention.

FIG. 9 is a flow chart including a method for producing a document at a point of need device, according to an embodiment of the invention.

FIG. 10 is a block diagram of a computer readable medium that includes an instruction set thereon, according to an embodiment of this invention.

FIG. 11 is a schematic diagram of a network used to pay for a particular print job or finished document on the point of need device for generating finished documents, according to an embodiment of this invention.

### DETAILED DESCRIPTION OF THE INVENTION

In the following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples.

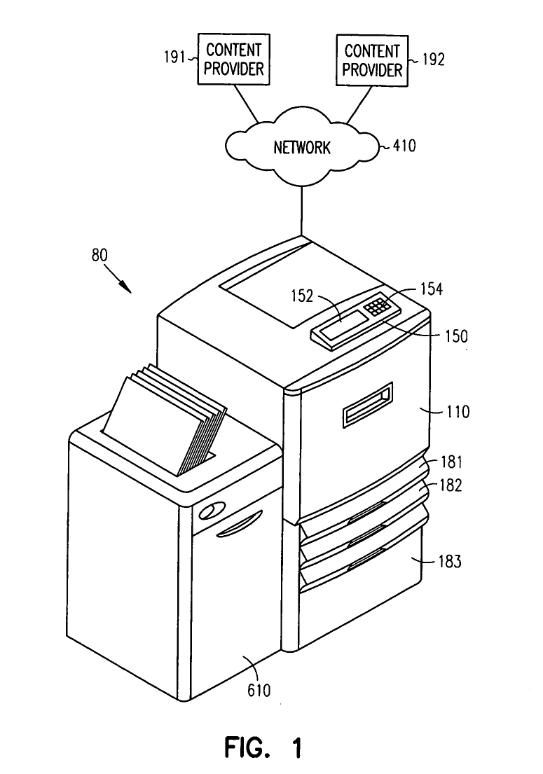

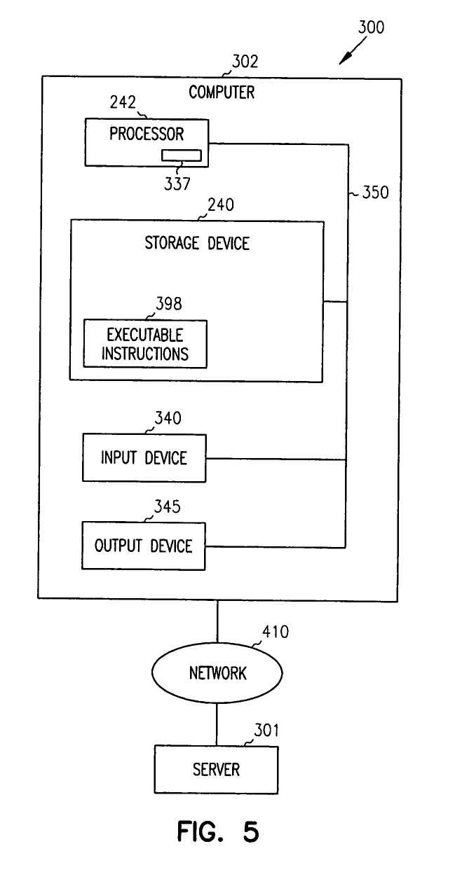

FIG. 1 is a perspective view of a point of need printing device 80, according to an embodiment of this invention. The point of need printing device 80 includes an imaging apparatus or printer 110 and an in-line finisher 610. The imaging apparatus 110 includes a user interface that includes a control panel 150, a display 152 and a keypad 154. The interface, which comprises the control panel 150, the display 152, and the keypad 154, is one embodiment of a user interface for the point of need printing device 80. In other embodiments, the point of need printing device 80 may include a separate computer or information handling system (shown and discussed in FIG. 5) that is used to control the functions of the point of need printing device 80. In this other embodiment, a separate computer and separate display would be added to the point of need printing device 80 shown in FIG. 1. In this other embodiment, the control panel 150, the display 152 and the keypad 154 would remain associated with the imaging apparatus 110 of the point of need printing device 80.

The imaging apparatus 110 would also include a first paper tray 181, a second paper tray 182, and a third paper tray 183. Each of the paper trays 181, 182, 183 holds a different type of paper used to produce finished documents using the point of need printing device 80. The point of need printing device 80 also includes an in-line finisher 610. The in-line finisher finishes the document so that the finished document output from the point of need printing device 80 is comparable in quality to documents created at commercial print shops. The in-line finisher 610 is capable of performing one or more finishing steps such as lamination of one or all pages of a document, document stacking, saddle stitching, or trimming. In the trimming operation, the pages are trimmed to produce a custom-sized document or a flat-edged booklet. Trimming can also be used to produce a full bleed feature for a page or document. In other embodiments of the invention, the in-line finisher 610 includes perforation, high capacity stacking, binding of the document, hole punching, three-ring binder insertion, cover insertion, auto packaging, and folding of the document. In addition, the in-line finisher 610, in some embodiments, may include direct mail finishing such as sealing labels and postage metering.

The point of need printing device 80 also includes an interface or connection to a network 410. The network 410 can be a wide area network or a local area network or can be the Internet or a similar network. Also attached to the network 410, is a first content provider 191, and a second content provider 192. In actuality, a plurality of content providers 191, 192 will be attached to the network 410. The content providers 191, 192 provide or sell content to a user who is designing and forming a document using the point of need printing device 80. In some embodiments of the invention, the content providers 191, 192 are associated with the company of the user. In such an embodiment, a company may have a marketing department that produces high-quality brochures for various sales meetings. The content providers 191, 192 can be different arms of the same company that provide content used in marketing materials. In still other embodiments of the invention, the content providers 191, 192 may be other arms located within a marketing department.

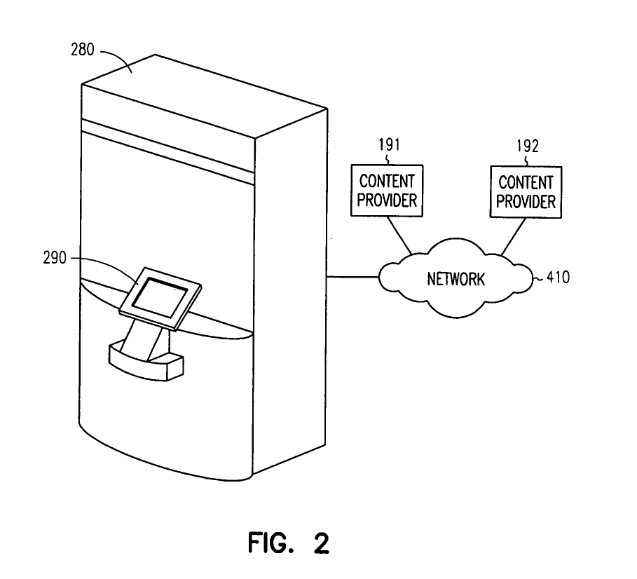

FIG. 2 is a perspective view of a point of need printing device kiosk 280, according to an embodiment of this invention. The point of need printing device kiosk 280 houses imaging apparatus 110 and an in-line finisher 610 (both of which are shown in FIG. 1). The point of need printing kiosk 280 includes a user interface 290 which allows a user to input selections for designing a document using the point of need printing device kiosk 280, shown in FIG. 2. The point of need printing device kiosk 280 also includes a keyboard and other user interface devices that are necessary to input commands to the imaging apparatus and in-line finisher within the point of need printing device kiosk 280. It should be noted that the user interface 290 shown in FIG. 2 is only an example of a user interface. Other user interfaces may be employed, such as a microphone into which a user's verbal commands are converted to actual commands using voice recognition software. Other input devices or user interfaces are also contemplated in other embodiments of this invention.

The point of need printing device kiosk 280 also includes an interface to a network 410. The network 410 is any type of network including a wide area network, local area network, or Internet or the like. Content providers 191, 192 are also attached to the network 410. The content providers 191, 192 attached to the network 410 provide or sell content to a user who is producing a document using the point of need printing device kiosk 280. The user 290 issues commands and designs the document via the user interface. The content is provided by the content providers 191, 192. The user has the ability to search all of the content providers 191, 192 for articles or content that is of interest to the user. For example, if the user is interested in fly fishing, the user can search the content of the various content providers 191, 192 for articles on fly fishing, sections of books on fly fishing, or sections of newspapers that discuss tying flies or other specialized subjects related to fly fishing. The user may search the various content providers 191, 192 for content of interest at the time of forming the document. Optionally, the user may set up a automatic poling search engine having a standing search of any new content provided by the content providers 191, 192. Thus, when the user signs on or uses a point of need printing kiosk 280 or one of many kiosks in a network of kiosks 280, the user is recognized and the standing search of new content is presented or given to the user. The user can browse the search results to determine which of the various content he or she would like to include in a document. The end result is that a user can produce a customized document that includes content from a plurality of content provides a custom document, for example, may include a portion of a book, a portion of a magazine, a portion of a newspaper or a portion of any type of content or any combination of the above.

The in-line finisher 610 (shown in FIG. 1) also has differing capabilities so that the user may select from these capabilities to determine both the look and quality of the document output from the point of need printing device kiosk 280, and the cost of the document. The point of need printing device kiosk 280, as well as the point of need printing device 80, in some embodiments, includes a cost estimating program capable of determining or estimating costs associated with a document produced and finished as selected by a user.

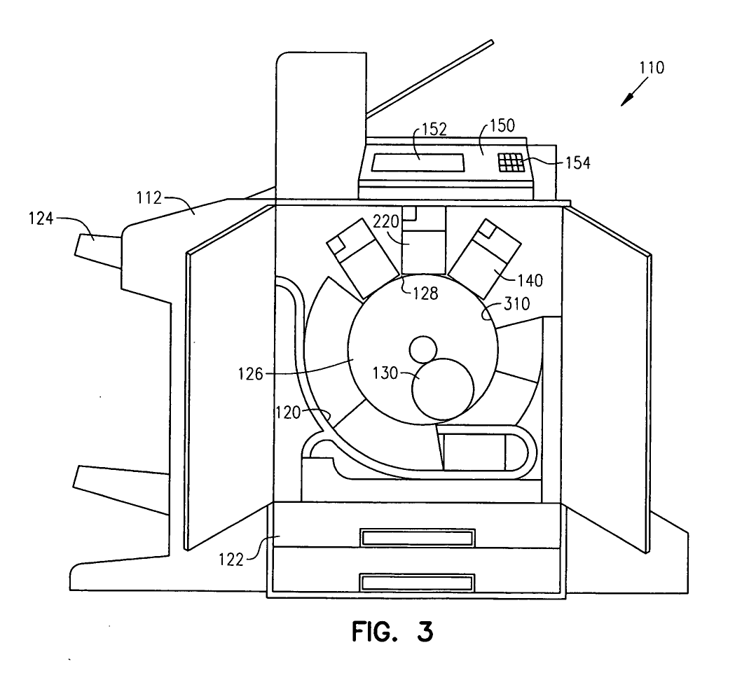

FIG. 3 shows one embodiment of the imaging device 110, according to one embodiment of this invention. FIG. 3 includes a high-speed inkjet printer 110 that is used in an office environment for printing business reports, correspondence, and the like. The inkjet printer is an example of an imaging apparatus. The imaging apparatus could be another type of printer, scanner or facsimile machine. Other types of printers include laser printers, desktop ink jet printers and the like. In addition, the imaging apparatus could be a multifunction peripheral device capable of printing, scanning and faxing. The imaging device 110, as shown in FIG. 3, includes a chassis 112 and a print media handling system 120 for supplying a print media. The print media handling system 120 includes at least one media input tray 122, a media output tray 124 and a media or paper path 126. The media or paper path 126 includes a series of rollers 130 that position the paper to receive ink from an ink source 140. In addition to the rollers 130, the media or paper path 126 includes a print drum 310. The print drum 310 moves the paper or media into a print zone 128. The ink source 140 is positioned near the print drum 310 in the print zone 128. In this embodiment, the source of ink source includes a plurality of ink jets 220 positioned around a portion of the print drum 310. It should be understood that the ink source 140 is not limited to a plurality of ink jets and could be any other source of ink. Furthermore, the print media used includes any type of suitable sheet material, such as paper, photo-quality paper, card-stock, transparencies, Mylar®, foils, and any other similar print media. The printing apparatus also includes a control panel 150. The control panel includes a display 152 and a keypad 154 for inputting commands to the printing apparatus 110. Parameters related to a print job are displayed on the display 152. Selections are made at the keypad 154. After a selection is made, the result is displayed on the display 152.

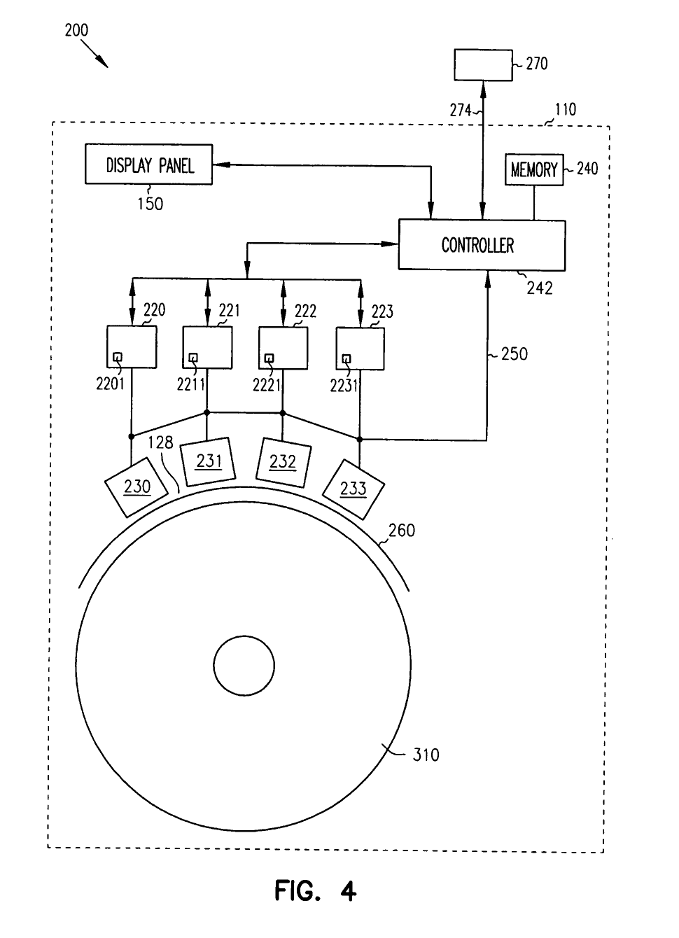

FIG. 4 is a schematic view of a printing apparatus 200 that includes the printer or imaging apparatus 110 with a printer controller 242, according to an embodiment of the invention. A source of commands 270 is attached to the high-speed inkjet printer 110. The controller 242 generally receives instructions from the command source 270. The command source can be a host computer connected directly to the imaging apparatus or a device attached to a network. In the case of the latter, the imaging apparatus is also attached to a network.

The controller 242 controls many aspects of the imaging apparatus 110. A memory 240 is attached to the controller 242. The command source 270 is also attached to the controller 242. The controller 242 is communicatively coupled to the command source 270. The command source 270 is shown connected to a display device 150. The command source 270 can be a variety of information sources such as a personal computer, work station, or server, or any other computing device, that provides image information to the controller 242 by way of a data link 274. The data link 274 may be any one of a variety of data links such as an electrical link, radio frequency link, or an infrared link. The data link transfers information between the command source 270 and the imaging apparatus 110. The imaging apparatus 110 includes the entire schematic arrangement shown in FIG. 2. Generally, the dotted line box, designated by the reference number 110, includes the components associated with the imaging apparatus 110.

The controller 242 controls the transfer of information between the command source 270 and a plurality of printheads 230, 231, 232 and 233 in the print zone 128 of the printing apparatus. The controller 242, in some embodiments of the invention, can monitor ink type and ink color in a plurality of reservoirs 220, 221, 222, and 223. The memory 240 also contains information as to the levels of ink within the various reservoirs 220, 221, 222, 223. In some embodiments, a fluid level sensor 2201, 2211, 2221, and 2231 is located to monitor the level of each of the various reservoirs 220, 221, 222, 223, respectively. The fluid level determined by the fluid level sensor 2201, 2211, 2221, and 2231 is placed into memory 240. Electrical contacts associated with each of the reservoirs 220, 221, 222, 223 receive signals over conductive paths represented by the line 250. It should be noted that only four printheads are shown in the schematic of FIG. 4 and that in other embodiments of this invention there may be many more printheads in the print zone 128. Thus the controller 242 is capable of determining the amount of ink used at various points in the printing process. In addition, the memory can store the cost associated with an amount of ink in each of the reservoirs 220, 221, 222, 223.

Various parameters can be stored in the storage device or memory 240, including an actual count of ink drops emitted from a particular printhead 230, 231, 232, 233, data associated with an ink reservoir or container 220, 221, 222, 223, as well as the ink type and color, the container size, the age of the ink, the printer model or identification number, and cartridge usage information. In other embodiments, a print command includes an indication of the paper type and information can be obtained from the print command regarding the type of print media being used. For example, in embodiments of printers where multiple paper trays are available, the type of print media must be designated as relating to a particular tray. In other embodiments, the resolution setting indicates that high-quality photo type print media is being used. The parameters listed above are just examples of the listings of parameters storable within the memory 240.

The controller 242 also controls other aspects of the imagining apparatus 110. For example, the controller 242 controls the source of the media used for a print job. An imaging apparatus, in some embodiments, is outfitted with a plurality of input media trays. A print command includes an indication of the paper type to be used for a print job. The various types of paper or media and their association with various print trays is stored in the memory 240 coupled to the controller 242. Therefore, in fulfilling a print command, the controller designates the print tray having the appropriate type of media or paper required by the print job. The costs of the various media can also be stored within memory 240 so that the cost associated with a print job can be determined from information in the print job, or information regarding the paper tray used for a print job and the associated cost with the media used. In addition, the memory can hold an amortized cost as well as the number of pages that can be printed over the time of amortization. Therefore an amortized cost related to the costs of wear and tear on the printing device per sheet of media can be determined by the controller 242 using information stored in the memory 240 as well a count of the number of pages associated with a print job.

The controller 242 can be either a microprocessor, a computer system, or a dedicated controller. Many times the controller 242 is associated with an information handling system that is any device that stores, manipulates or handles information. A high-speed type printer is described in FIGS. 1 and 2. It should be noted that the high-speed printer is one example of imaging apparatus. The invention is also applicable to all other types of imaging apparatus and printers.

FIG. 5 is a schematic diagram of an electronic device 300 that includes the controller 242 and memory 240, according to an embodiment of the invention. The electronic device 300 includes a computing system 302. The computing system 302 includes the controller 242 and a storage device or memory 240. The storage device 240 includes executable instructions 398. The executable instructions 398 are stored within the storage device 240. In one embodiment, the computing system 302 is integrated into an imaging device 110 that includes software or firmware that instructs the controller 242 with respect to various operations associated with the set of executable instructions. The computing system 302 may be entirely within the imaging apparatus 110 or a portion of the computing system 302 may be within the imaging apparatus 110. The electronic device 100 also includes a network 410 and a server 301. The computing system 302 is communicatively coupled to the network 410. The network 410 and the computing system 302 are communicatively coupled to the server 301. Other peripheral devices can also be attached to the network 410.

The controller 242 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The controller 242 executes instructions and includes that portion of the electronic device 301 that controls the operation of the entire electronic device. Although not depicted in FIG. 5, the controller 242 typically includes a control unit 337 that organizes data and program storage in memory and transfers data and other information between the various parts of the electronic device 301. The controller 242 receives input data from the input device 340 and the network 410, reads and stores code and data in the storage device 240, and presents data to an output device 345 and/or the network 410.

Although the electronic device 300 is shown to contain only a single controller or processor 242 and a single bus 350, the present invention applies equally to electronic devices that may have multiple processors and multiple buses with some or all performing different functions in different ways.

The memory or storage device 240 represents one or more mechanisms for storing data. For example, the storage device 240 may include read only memory (ROM), random access memory (RAM), magnetic disk storage media, optical storage media, flash memory devices, and/or other machine-readable media. In other embodiments, any appropriate type of storage device may be used. Although only one storage device 240 is shown, multiple storage devices and multiple types of storage devices may be present, and in various embodiments some or all of the product codes, the control unit 337, and the products may be stored on the same or on different storage devices. Further, although the electronic device 100 is drawn to contain the storage device 240, it may be distributed across other electronic devices, for example on computers attached to the network 410.

The control unit 337 includes instructions capable of being executed on the controller or processor 242 to carry out the functions of the present invention. In another embodiment, some or all of the functions of the present invention are carried out via hardware in lieu of a processor-based system.

The input device 340 may be a keyboard, mouse or other pointing device, trackball, touchpad, touchscreen, keypad, microphone, voice recognition device, data recorder, data recognition device or any other appropriate mechanism for the user to input data to the electronic device 300. Although one input device 340 is shown, in another embodiment any number (including none) and type of input devices may be present.

The output device 345 is that part of the electronic device 300 that communicates output to the user. The output device 345 may be a cathode-ray tube (CRT) based video display. In other embodiments, the output device 345 may be a liquid crystal display (LCD) based flat panel display or gas, plasma-based, flat-panel display. In another embodiment, the output device 345 may be a speaker. In still other embodiments, any appropriate output device may be used. Although one output device 345 is shown, in other embodiments, any number (including none) of output devices of different types or of the same type may be present.

The bus 350 may represent one or more busses, e.g., PCI, ISA (Industry Standard Architecture), X-Bus, EISA (Extended Industry Standard Architecture), or any other appropriate bus and/or bridge (also called a bus controller).

The electronic device 300 may be implemented using any suitable hardware and/or software, such as a personal computer. Portable computers, laptop or notebook computers, PDAs (Personal Digital Assistants), pocket computers, telephones, pagers, appliances, and mainframe computers are examples of other possible configurations of the electronic device 301. The hardware and software depicted in FIG. 5 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted.

The network 410 may be any suitable network and may support any appropriate protocol suitable for communication between the electronic device 300 and other electronic devices. In an embodiment, the network 410 may support wireless communications. In another embodiment, the network 410 may support hard-wired communications, such as a telephone line or cable. In another embodiment, the network 410 may support the Ethernet IEEE (Institute of Electrical and Electronics Engineers) 802.3x specification. In another embodiment, the network 410 may be the Internet and may support IP (Internet Protocol). In another embodiment, the network 410 may be a local area network (LAN) or a wide area network (WAN). In another embodiment, the network 410 may be a hotspot service provider network. In another embodiment, the network 410 may be an intranet. In another embodiment, the network 410 may be a GPRS (General Packet Radio Service) network. In another embodiment, the network 410 may be any appropriate cellular data network or cell-based radio network technology. In another embodiment, the network 410 may be a wireless network. In still another embodiment, the network 410 may be any suitable network or combination of networks. Although one network 410 is shown, in other embodiments any number of networks (of the same or different types) may be present.

Aspects of an embodiment pertain to specific apparatus and method elements implementable on a computer or other electronic device. In another embodiment, the invention may be implemented as a program product for use with an electronic device. The programs defining the functions of this embodiment may be delivered to an electronic device via a variety of signal-bearing media, which include, but are not limited to:
(1) information permanently stored on a non-rewriteable storage medium, e.g., a read-only memory device attached to or within an electronic device, such as a CD-ROM readable by a CD-ROM drive;
(2) alterable information stored on a rewriteable storage medium, e.g., a hard disk drive or diskette; or
(3) information conveyed to an electronic device by a communications medium, such as through a computer or a telephone network, including wireless communications.
   Such signal-bearing media, when carrying machine-readable instructions that direct the functions of the present invention, represent embodiments of the present invention.

The imaging apparatus 110, and the electronic apparatus 300 associated with the imaging apparatus (as described in FIGS. 1-5) form a system for allocating costs associated with operation of the imaging apparatus. The system for allocating costs includes the device or memory 242 storage system for storing information about a cost per sheet of media associated with the imaging apparatus, and the cost of ink associated with the imaging apparatus. The computing system 302 coupled with the memory or storage device 240 receives a print job and records the actual number of sheets of media used to execute the print job, and records an amount of ink used on each sheet of media for execution of the print job. The processor or controller 242 multiplies the actual number of sheets of media used by the cost per sheet of media and adds the cost of ink for each of the pages to determine a cost associated with the print job. The processor or controller 242 also allocates the cost of the print job to an entity. The entity may be a branch office of a company or the user of a point of need kiosk.

In some embodiments, the storage device 240 stores the cost of the ink as a cost per dot of ink. The processor or controller 242 records the number of dots per page and multiplies the number of dots on a particular page by the cost per dot to determine the cost of ink per page. The cost per dot of ink varies as a function of the density of dots on a page varies.

The storage device 240 stores the varying cost per dot and related dot densities per page. The storage device 240 also stores amortized costs associated with each sheet of media. The processor or controller 242 adds the amortized cost per sheet of media to the cost of the sheets of media and the cost of the ink. Allocating the cost of the print job to an entity includes storing a billing code in the data storage system that is associated with an entity. The processor 242 reads a billing code associated with the print job and allocates the cost of the print job to the entity associated with the billing code.

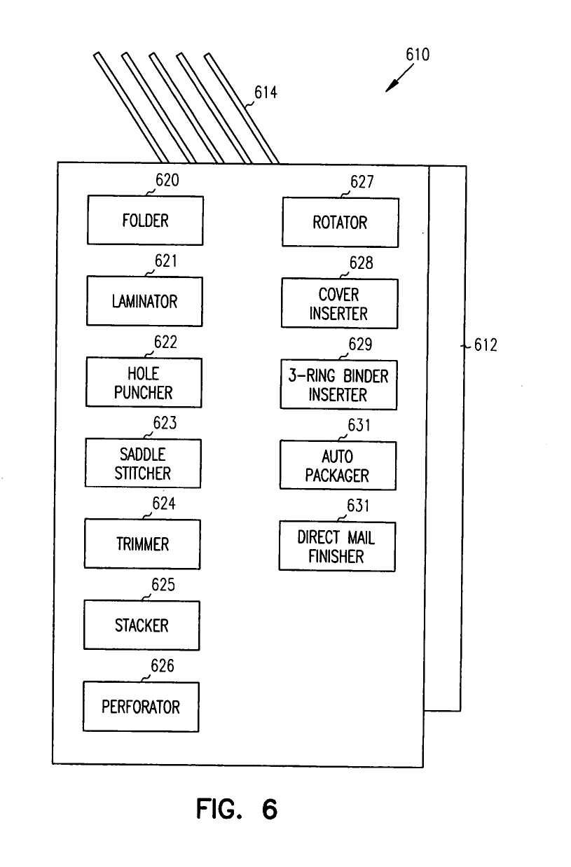

FIG. 6 is a schematic diagram of an in-line finisher 610, according to an embodiment of this invention. The in-line finisher 610 includes an interface 612 to the imaging apparatus 110 (shown in FIGS. 1, 3, and 4), and a document output 614. The document output 614 includes a plurality of trays that hold finished documents that are output from the in-line finisher 610. The in-line finisher includes a folder 620, a laminator 621, a hole puncher 622, a saddle stitcher 623, a trimmer 624, a stacker 625, a perforator 626, a rotator 627, a cover inserter 628, a three-ring binder inserter 629, an auto packager 630, and a direct mail finisher 631. The folder 620 folds individual pages or entire documents. A laminator 621 is used to laminate pages of the document. A hole puncher 622 is used to punch holes into a document. For example, holes may be punched into a document using the hole puncher so that the three-ring binder inserter 629 can be used to place the document within a three-ring binder. A saddle stitcher 623 is used to bind a document. A trimmer is used to produce pages of a custom size or to make sure that all the pages are aligned by trimming off the edges of the pages of a stacked document. The stacker is used to stack various pages within a document, and the perforator is used to perforate the document, while the rotator 627 is used to perform an L-R rotation. The rotator 627 rotates individual pages to proper orientation in the final document. The cover inserter 628 places a cover on a document that will be presented for marketing, or it can be used to place a cover on a document intended to be kept indefinitely. An auto packager 630 provides for placing a document inside a package and a direct mail finisher 631 includes a postage meter and a label maker for addressing packages and preparing packages, including custom made documents for a direct mail marketing campaign. A cost is associated with consumables used by the various mechanisms 620-631. It should be noted that each document that is formed need not necessarily be manipulated using all of the mechanisms 620-631. But the document produced may only be trimmed, for example, by the trimmer rather than having a full complement of functions performed thereon. A document that only has one function performed thereon will be less expensive than a document that gets treatment from more than one of the various mechanisms 620-631. It should also be noted that in other embodiments of the invention, the in-line finisher may have less than all the various finishing devices discussed above. Other embodiments may include in-line finishers with more and different capabilities than discussed above.

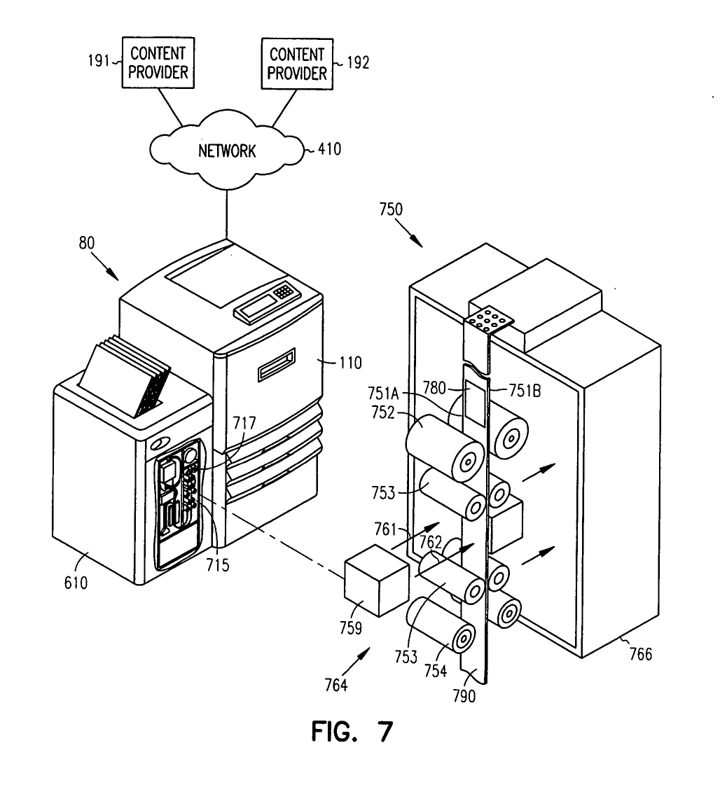

As shown in FIG. 7, the point of need printing device 80 has an in-line finisher 610 that includes a lamination module 750. With specific reference to FIG. 7, the lamination module 750 includes a lamination assembly 764 and a module logic unit 766 linked with the lamination assembly 764. The module logic unit 766, in operation, generates imaging instructions. The lamination assembly 764, in turn, forms an image from a plurality of printed sheets 780 based on the imaging instructions.

The lamination assembly 764 is configured for laminating one or both sides of the two sides provided by each printed sheet 780. As shown in FIG. 7, the lamination assembly 764 features an application arrangement 751 including a first application surface 751a and a second application surface 751b. Each application surface 751a, 751b applies lamination media 790 to one respective side of the printed sheet 780. Therefore, in general, component elements comprising the lamination assembly 764 for use with the first application surface 751a are identical to component elements for use with the second application surface 751b.

Accordingly, for purposes of illustration, consider the component elements of the lamination assembly 764 for use with the first application surface 751a. and a driver roller 754 opposingly positioned from the supply roller 752 along the first application surface 751a. The supply roller 752 includes laminate media 790 in stock form. As discharged from the supply roller 752, laminate media 790 laminates one side of the printed sheet 780 along the first application surface 751a. In stock form, the laminate media 790 is removably attached to a substrate (not shown). In operation, laminate media 790 in stock form is taken from the supply roller 752 and disposed on one side of the printed sheet 780 so that the residual substrate is taken up by the driver roller 754.

The lamination assembly 764 also includes a plurality of take rollers 753. Operatively, the take rollers 753 exert compressive and tensile forces or, as commonly referred to, “nip” against the lamination media 790, as is required for laminating one side of the printed sheet 780. Shown in FIG. 7, the nip is referenced as arrow 761. It should also be added that at least one take roller 753 is positioned adjacent to the supply roller 752 and to the driver roller 754 as well.

The lamination assembly 764, in a preferred embodiment, includes a heat source 759. Preferably, the heat source 759 is placed adjacent to the take rollers 753. As indicated on FIG. 7 by heat vector 762, the heat source 759 sends heat energy to the laminate media 790. In conjunction with the nip provided by the take rollers 753, the heat source 759 emits heat energy to thereby laminate one side of the printed sheet 780.

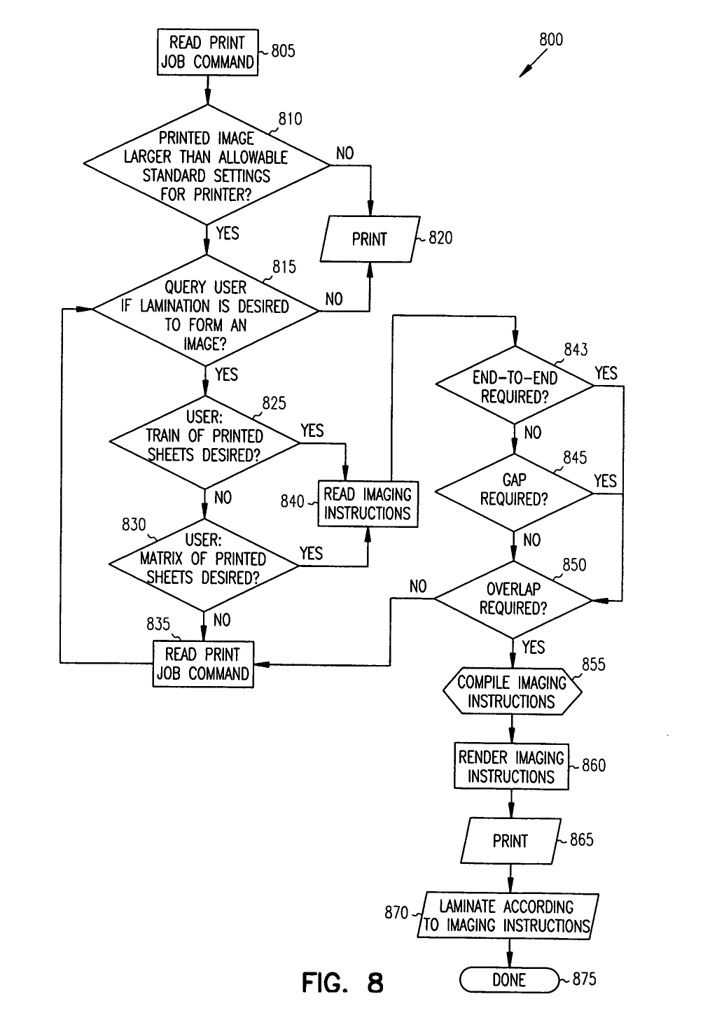

Referring now to FIG. 8, with reference to the module logic unit 766, the printing system 110 sends a print job command to the module logic unit 766. Based on the print job command, the module logic unit 766 executes a lamination finishing sequence 800 of FIG. 8 to facilitate generation of imaging instructions. From the imaging instructions, the lamination finishing sequence 800 facilitates operation of the lamination assembly 764 (shown in FIG. 7) to form an image from a plurality of printed sheets.

As illustrated in step 805 of FIG. 8, the module logic unit 766 initiates the lamination finishing sequence by reading the print job command sent from the printing system 110. In step 810, the module logic unit 766 determines whether the print job command requires forming an image through lamination.

In a preferred embodiment, step 810 determines whether the desired printed image is larger than allowable standard settings for the printing system 110. The standard settings are preset within the printing system 110 by default and normally print an image on a single printed sheet 780. For a desired printed image that is within the standard settings, the module logic unit 766 in step 820 defers to the printing system 110 to print that desired image.

However, if larger than the standard settings, the module logic unit 766 in step 815 queries a system user if lamination is desired to form the needed image. If lamination is not desired, the module logic unit 766 in step 820 defers to the printing system 110 to print the image in a series of printed sheets 180. Without choosing the lamination module 750 to form the desired image through lamination, the system user must manually collect, arrange, and form the desired image with that series of printed sheets.

The lamination finishing sequence advances from step 815 to 825. Prior to forming the desired image with the lamination module 750, the module logic unit 766 determines user preferences in steps 825, 830, 843, 845, and 850. Generally, user preferences are gathered from the document command. User preferences are a combination of instructions operationally generated from the system and received from system user input. Once the user preferences are gathered, the imaging instructions are compiled 855 and rendered 860. The image is then printed 865 and the output from the printing operation are laminated according to the imaging instructions 870. After lamination, the lamination finishing sequence 800 is done 875.

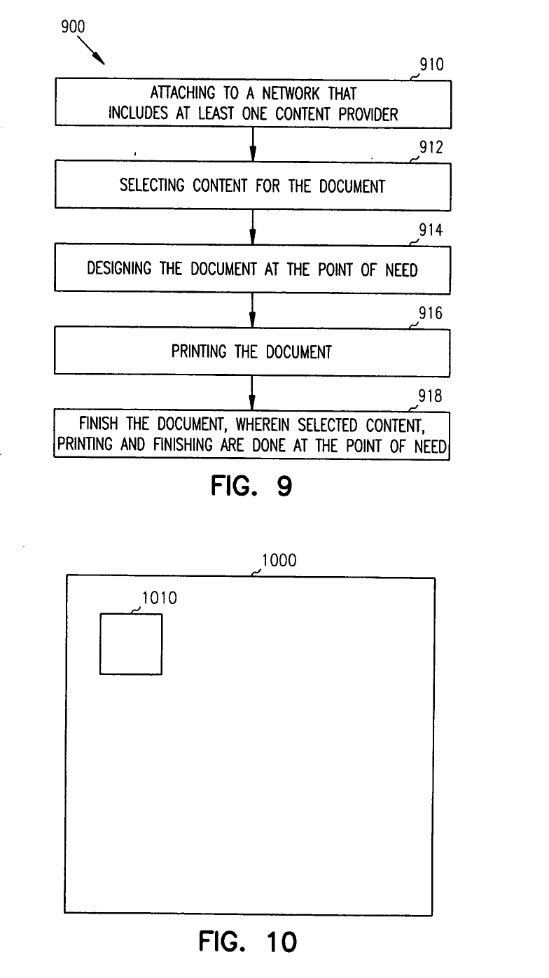

FIG. 9 is a flowchart including a method for producing a document at a point of need device 900, according to an embodiment of this invention. The method 900 includes attaching an imaging device 110 to a network that includes at least one content provider 910, selecting content for a document 912, designing the document at the point of need 914, printing the document 916, and finishing the document 918. Finishing the document, selecting the content and printing and finishing are done at the point of need. The method for producing a document at a point of need 900 includes selecting content for the document 912, printing the document 916, and finishing the document 918. The selection of content, printing and finishing are done at the point of need. The method also includes designing the document at the point of need 914. Designing the document further includes selecting one of a plurality of document templates. The plurality of document templates associate a format with the document. The method 900 also includes estimating the cost of the selected content. Selecting content for the document 912 includes attaching to a network that includes at least one content provider 912. In some embodiments, selecting content for the document includes polling a network of content providers for articles related to a selected subject. In other embodiments, selecting content includes selecting marketing material from another branch or division within a company. The method also includes paying or allocating the cost for the selected content. The method also includes proofing the custom document. Of course there are several types of proofing, however, proofing an embodiment of the invention housed in a kiosk occurs at a monitor on a personal computer before final printing of the document. The method 900 further includes approving the custom document before printing the custom document. In some embodiments, finishing the custom document includes lamination of the pages. In other embodiments, finishing the custom document includes stacking of the pages. In still other embodiments, finishing the custom document includes trimming of the pages.

Designing the document at the point of need 914, as mentioned above, also includes selecting one of a plurality of document templates. As various selections are made with respect to content of the document, as well as formatting of the document, a job ticket is built within the point of need automatic document device. The job ticket will be print job and the instructions for carrying out the print job necessary to finish the document. In some embodiments, the template will contain formats that match the capabilities of the particular point of need device. For example, if the point of need device includes a laminator 621, a stacker 625 and a perforator 626 (all shown in FIG. 6) and does not include a direct mail finisher 631 (also shown in FIG. 6) the various packages that are available as document templates will include various combinations of lamination, stacking, and perforation. The document templates will not include direct mail finishing since it is not available at the particular point of need device.

In addition, in some embodiments, the various templates will include a fixed quantity of pages of media. When the templates include various fixed numbers of pages it is easier to keep track of the inventory of pages within the point of need device. In other words, each of the templates will have a fixed number of pages available for the print job. For example, if a user would like package one, the document template would allow 50 laminated pages that are stacked and perforated. There will be other packages representing other possible templates that could be used, such as package two, which might have only 25 perforated, stacked and laminated pages. A third package might have 25 pages that are stacked. In this way, it is much easier to track the inventory and consumable items, such as paper, and lamination materials available to the point of need device. Tracking the limited number of templates or packages executed by a point of need device allows a very accurate estimate of the amount of consumables left or available by multiplying the amount of resources used per package times the number of packages of a particular type. Adding the totals determines the inventory that is used. Once the inventory that is used has been determined, the amount of consumables can be subtracted from those available at a previous time so that a person maintaining the point of need device can know exactly, or estimate very closely, the amount of consumable items necessary to restock the point of need device.

In addition, using templates or packages also helps with respect to projections of use of a particular point of need device. The types of packages that are used can be watched for trends so that the mix of packages and templates can be predicted. Once a prediction is made the point of need device is appropriately restocked so that it can produce a maximum number of the most desired packages or templates. Thus, the use of templates and monitoring the number of templates or number of packages associated with the templates provides for better and easier consumable management on each of the point of need devices in the field.

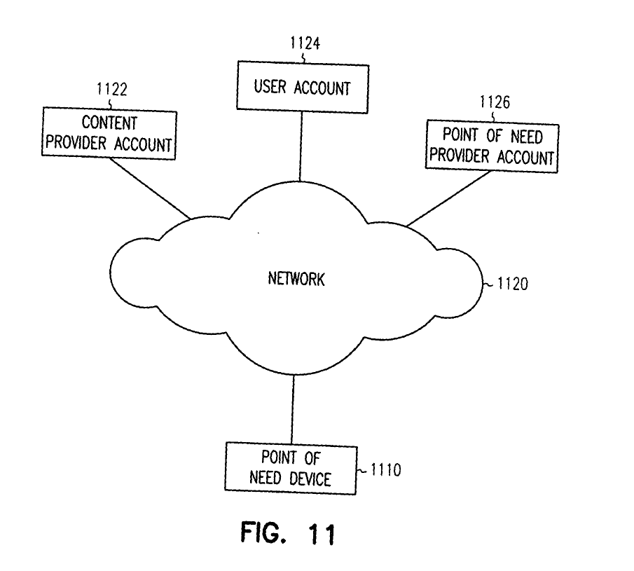

Of course, before printing or producing a document from a point of need device, costs must be approved and allocated to the user. Generally, payment is secured after the user has proofed the print job but before printing. FIG. 11 is a schematic diagram of a network used to pay for a particular print job or finished document on point of need automatic document machines, according to an embodiment of this invention. A point of need device 1110 for generating finished documents is attached to a network 1120 such as the internet, WAN or LAN. The network 1120 includes or provides access to a content provider account 1122, a user account 1124, and a point of need provides account 1126. The point of need device 1110 generates a cost associated with generating a finished document. The user approves the costs that in turn accesses the user account 1124 and pays funds into the content provide account 1122 and to the point of need device provide account 1126. It should be noted that the cost includes a separate price for content, as well as consumables. The cost for content is paid to content provider account 1122 and the cost for consumables and for the service is paid to the point of need provider account 1126. In some embodiments, the user account 1124 is a credit card account. Upon approval by the user of the credit card account, the third-party account provider will check to make sure that the funds amount needed to pay the cost for the particular print job at the point of need device is available. Once approved, the credit card is charged or the user account 1124 on the network 1120 is charged and the cost is paid both to the content provider account 1122 as well as to the provider of the point of need device account 1126. Of course, in some embodiments of the invention, there is a plurality of content provider accounts 1122. In still other embodiments, there is a plurality of point of need provider accounts 1126. It should be noted that when a point of need device 1110 for automatically generating finished documents is used within a company, the user account 1124, the content provider account 1122 and the point of need provider account 1126 may be accounts associated with different portions of a company. Once payment is made, the print job then is completed.

FIG. 10 is a block diagram of a computer readable medium 1000 according to an embodiment of this invention. The computer program product for use with a computer system associated with a printing device 110 includes a computer usable medium 1000 having a set of instructions executable 1012 by a suitably programmed information handling system embodied in the computer usable medium. The set of instructions 1010 causes the computer system to select content for the document, print the document, and finish the document. The selection of content, printing, and finishing are done at a location where there is a point of need. In some embodiments, the computer usable medium further causes the computer system to provide a plurality of document templates for associating a format with the document. In other embodiments, the computer usable medium further causes the computer system to estimate a cost of a document having a selected content and a selected finish.

An apparatus for publishing a customized document includes an interface to a network of computing devices, a search engine for accessing content of interest, and a device for printing and finishing a document including content from a content provider. In one embodiment, the apparatus for publishing a customized document is housed within a kiosk 280. The device for printing and finishing a customized document further includes an imaging device 110, and a finishing device 610. The imaging apparatus 110 includes a database having a plurality of templates for a selected content of interest. The plurality of templates are used to format and print a customized document. The plurality of templates includes user-defined structure, status fields and parameters for customization of the customized document. The apparatus for publishing a customized document further includes a device for proofing a customized document. At least one source of content 191, 192 is attached to the network 410. The search engine for accessing content of interest is adapted to search the at least one source of content attached to the network. In other embodiments of the apparatus for publishing a customized document, a plurality of sources of content are attached to the network. The search engine for accessing content of interest is adapted to search the plurality of sources of content attached to the network. In some embodiments, the finishing device is an in-line finisher. Different embodiments of the finishing device include a laminator, an apparatus for saddle stitching the custom document, a trimmer, and a folder.

A system for printing a document includes a network 410 having a plurality of content providers 191, 192, and an imaging apparatus 110. The system 80 also includes a content selector for selecting less than all of the content from the plurality of content providers, a document formatter for formatting the selected content into a custom document, and a document finisher associated with the imaging apparatus for finishing the custom document. The content selector, the document formatter, and the document finisher of the system are located at a point of need. The system for printing a document further includes a cost estimator for estimating the cost of a document having selected content and having a selected finish. The system for printing a document also includes a data storage system for storing information related to the cost of content and the cost of a finished document.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

1. An apparatus for publishing a customized document comprising:
an interface to a network of computing devices;
a search engine for accessing content of interest; and
a device for printing and finishing a document including content from a content provider.

2. The apparatus of claim 1 wherein the apparatus for publishing a customized document is housed within a kiosk.

3. The apparatus of claim 1 wherein the device for printing and finishing a customized document further comprises:
an imaging device; and
a finishing device.

4. The apparatus of claim 3 wherein the imaging apparatus includes a database having a plurality of templates for a selected content of interest, the plurality of templates used to print a customized document.

5. The apparatus of claim 4 wherein the plurality of templates includes user-defined structure, status fields and parameters for the customized document.

6. The apparatus of claim 1 further comprising a device for proofing a customized document.

7. The apparatus of claim 1 further comprising at least one source of content attached to the network, wherein the search engine for accessing content of interest is adapted to search the at least one source of content attached to the network.

8. The apparatus of claim 1 further comprising a plurality of sources of content attached to the network, wherein the search engine for accessing content of interest is adapted to search the plurality of sources of content attached to the network.

9. The apparatus of claim 3 wherein the finishing device is an in-line finisher.

10. The apparatus of claim 3 wherein the finishing device includes a laminator.

11. The apparatus of claim 3 wherein the finishing device includes an apparatus for saddle stitching the custom document.

12. The apparatus of claim 3 wherein the finishing device includes a trimmer.

13. The apparatus of claim 3 wherein the finishing device includes a folder.

14. A method for producing a document at a point of need comprising:
selecting content for the document; and
printing the document; and
finishing the document, wherein selecting content, printing and finishing are done at the point of need.

15. The method of claim 14 further comprising designing the document at the point of need.

16. The method of claim 15 wherein designing the document further comprises selecting one of a plurality of document templates, the plurality of document templates associating a format to the document.

17. The method of claim 14 wherein selecting content for the document includes estimating the cost of the selected content.

18. The method of claim 14 wherein selecting content for the document includes coupling to a network that includes at least one content provider.

19. The method of claim 14 wherein selecting content for the document includes polling a network of content providers for articles related to a selected subject.

20. The method of claim 17 further comprising paying for the selected content.

21. The method of claim 14 further comprising proofing the document.

22. The method of claim 14 further comprising approving the document before printing the document.

23. The method of claim 14 wherein finishing the document includes lamination of the pages.

24. The method of claim 14 wherein finishing the document includes stacking of the pages.

25. The method of claim 14 wherein finishing the document includes trimming of the pages.

26. A computer program product for use with a computer system associated with a printing device, the computer program product comprising a computer usable medium having a set of instructions executable by a suitably programmed information handling system embodied in the computer usable medium for causing the computer system to:
select content for the document; and
print the document; and
finish the document, wherein selecting content, printing and finishing are done at a location where there is a point of need.

27. The computer program product for use with a computer system associated with a printing device of claim 26, wherein the computer usable medium further causes the computer system to provide a plurality of document templates for associating a format with the document.

28. The computer program product for use with a computer system associated with a printing device of claim 26, wherein the computer usable medium further causes the computer system to estimate a cost of a document having a selected content and a selected finish.

29. A system for printing a document comprising: a network including:
a plurality of content providers coupled to the network; and
an imaging apparatus coupled to the network;
a content selector for selecting content from the plurality of content providers;
a document formatter for formatting the selected content into a custom document; and
a document finisher associated with the imaging apparatus for finishing the custom document.

30. The system for printing a document according to claim 29, wherein the content selector, the document formatter, and the document finisher are at a point of need device.

31. The system for printing a document according to claim 29, further comprising a cost estimator for estimating the cost of a document having selected content and having a selected finish.

32. The system for printing a document according to claim 31, further comprising a data storage system for storing information related to the cost of content and the cost of a finished document.

33. The system for printing a document wherein the network further comprises a second imaging apparatus.
